(19) United States
(12) Patent Application Publication
(10) Pub. No.: US 2011/0098933 A1
(43) Pub. Date: Apr. 28, 2011

(54) Systems And Methods For Processing Oximetry Signals Using Least Median Squares Techniques

(75) Inventor: James Ochs, Seattle, WA (US)

(73) Assignee: Nellcor Puritan Bennett Ireland, Mervue (IE)

(21) Appl. No.: 12/605,739

(22) Filed: Oct. 26, 2009

(51) Int. Cl. G06F 17/18; G06F 19/00

(52) U.S. Cl. 702/19; 702/179

(57) ABSTRACT

Methods and systems are disclosed for determining information from a signal using least median squares techniques, including determining blood oxygen saturation measurements based at least in part on photoplethysmograph signals. In an embodiment, a Lissajous figure is generated based on multiple measurements and least median squares techniques may be used for one or more of: determining information, assessing measurement confidence, filtering measurements, and choosing a regression analysis technique.

### SUMMARY OF THE DISCLOSURE

The present disclosure relates to signal analysis and, more particularly, the present disclosure relates to signal analysis using least median squares techniques in connection with, for example, physiological signals.

Many measurement systems require one or more signal processing steps to determine useful information from a measured signal. In some applications, these signal processing steps include determining a best-fit or regression curve from a series of one or more measurements.

One of the most common regression methods is the calculation of a linear regression curve using a least mean squares error metric. In such a method, a best-fit line is calculated by determining the parameters (e.g., slope and y-intercept) of a line that minimize the mean squared difference between the line and the measured data. These methods often have a closed-form solution, which may be computationally convenient, but are also vulnerable to poor performance when noise and outliers are introduced into the data. Indeed, such methods are known to have a “zero breakdown point,” which refers to the situation in which a single outlier is capable of rendering a least mean squares regression unreliable. Because many measurement signals, including physiological signals, are routinely subject to noise and outliers, least mean squares regressions may not always be suitable for these applications.

For example, a patient's blood oxygen saturation, among other physiological information, may be determined at least in part by analyzing a Lissajous figure of photoplethysmograph (PPG) signals obtained from a patient. The analysis may include determining a best-fit line between a PPG signal at a Red electromagnetic frequency and a PPG signal at an Infrared (IR) frequency (as discussed in detail below). In such calculations, an error of +/−0.1 in the slope of the line determined by a linear regression method may result in a blood oxygen saturation measurement error of +/−5%, which may trigger false alarms or result in missing a deterioration in a patient's health status.

For example, FIG. 1 depicts an illustrative Lissajous FIG. 102 obtained from PPG data including a single outlier 104. Dashed line 108 indicates the true slope of the curve relating the underlying PPG data, and solid line 106 indicates the best-fit line returned by a least mean squares regression. The depicted Lissajous FIG. 102 of FIG. 1 illustrates a 0.098 error in slope between true curve 108 and the least mean squares best-fit line 106, which results in a 4% error in the resulting blood oxygen saturation measurement.

FIG. 1 also depicts an illustrative Lissajous FIG. 110 obtained from PPG data corrupted by additive Gaussian noise. Dashed line 112 indicates the true slope of the curve relating the underlying PPG data, solid line 114 indicates the best-fit line returned by a least mean squares regression. The depicted Lissajous FIG. 110 of FIG. 1 illustrates a 0.45 error in slope between true curve 112 and the least mean squares best-fit line 114, which results in a 14% error in the resulting blood oxygen saturation measurement.

In some applications, least median squares regression methods may provide improved reliability in the presence of noise and outliers in a measured signal. The median value of a set of values is commonly defined as the middle value of an ordered set of values, or the value that separates the higher half of a set of values from the lower half of a set of values. Least median squares techniques may exhibit improved robustness over least mean squares regressions. For example, in Lissajous FIG. 102 of FIG. 1, solid line 107 indicates the best-fit line returned by a least median squares regression. Solid line 107 is difficult to distinguish from dashed line 108 (the true slope of the curve relating the underlying PPG data). Similarly, in Lissajous FIG. 110 of FIG. 1, solid line 113 indicates the best-fit line returned by a least median squares regression. As in Lissajous FIG. 102, solid line 113 is difficult to distinguish from dashed line 112 indicating the true slope of the curve relating the underlying PPG data of Lissajous FIG. 110. Least median squares techniques may be especially suitable for determining physiological information from signals representative of physiological processes (e.g., as illustrated by the examples of FIG. 1).

For measurements which exhibit variable susceptibility to noise and outliers, least median squares techniques may selectively utilize least mean squares calculations when noise is low to retain the computational benefits of these calculations. Least median squares techniques may also be applied to transformations of a measured signal, to filtered signals, or both. Transformations of a measured signal may include a representation of a measured signal in a different domain, such as a time-scale domain as a result of a continuous wavelet transformation.

Several methods and systems for using least median squares techniques for determining information are disclosed herein. In a patient monitoring setting, the physiological information determined by a least median squares technique may be used in a variety of clinical applications, including within diagnostic and predictive models, and may be recorded and/or displayed by a patient monitor.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 depicts the performance of linear least mean squares regressions and least median squares regressions on illustrative Lissajous figures in accordance with an embodiment;

FIG. 2(a) shows an illustrative patient monitoring system in accordance with an embodiment;

FIG. 2(b) is a block diagram of the illustrative patient monitoring system of FIG. 2(a) coupled to a patient in accordance with an embodiment;

FIGS. 3(a) and 3(b) show illustrative views of a scalogram derived from a PPG signal in accordance with an embodiment;

FIG. 3(c) shows an illustrative scalogram derived from a signal containing two pertinent components in accordance with an embodiment;

FIG. 3(d) shows an illustrative schematic of signals associated with a ridge in FIG. 3(c) and illustrative schematics of a further wavelet decomposition of these associated signals in accordance with an embodiment;

FIGS. 3(e) and 3(f) are flow charts of illustrative steps involved in performing an inverse continuous wavelet transform in accordance with an embodiment;

FIG. 4 is a block diagram of an illustrative signal processing system in accordance with an embodiment;

FIG. 5 is a flow chart of illustrative steps involved in determining information using a least median squares technique in accordance with an embodiment;

FIGS. 6(a) and 6(b) depict illustrative error curves in a least median squares technique in accordance with an embodiment; and

FIG. 7 is a flow chart of illustrative steps involved in determining information using noise characteristics in a least median squares technique in accordance with an embodiment.

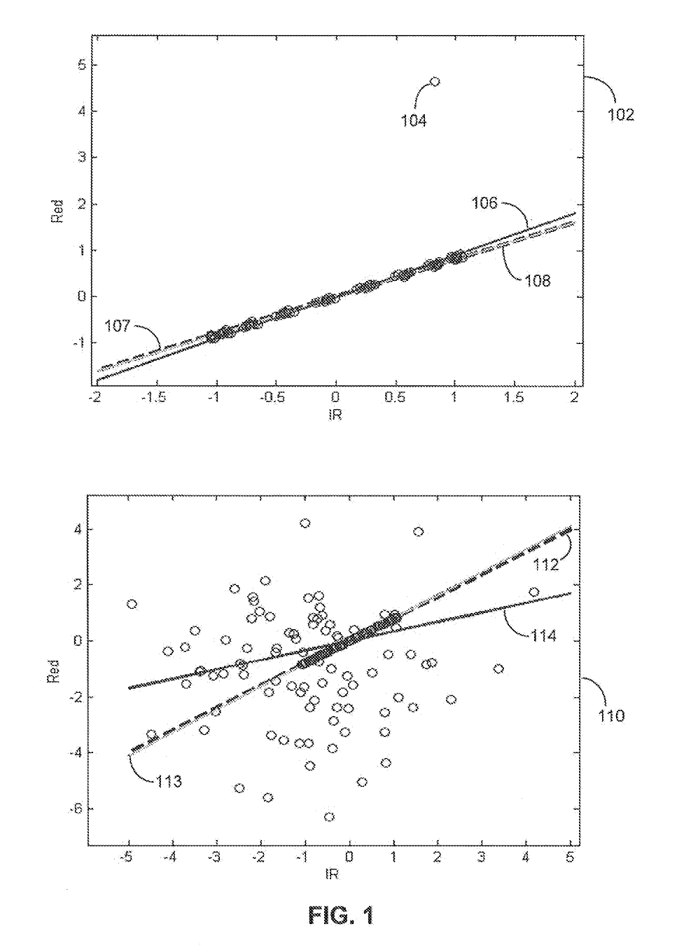

### DETAILED DESCRIPTION

An oximeter is a medical device that may determine the oxygen saturation of the blood. One common type of oximeter is a pulse oximeter, which may indirectly measure the oxygen saturation of a patient's blood (as opposed to measuring oxygen saturation directly by analyzing a blood sample taken from the patient) and changes in blood volume in the skin. Ancillary to the blood oxygen saturation measurement, pulse oximeters may also be used to measure the pulse rate of the patient. Pulse oximeters typically measure and display various blood flow characteristics including, but not limited to, the oxygen saturation of hemoglobin in arterial blood.

An oximeter may include a light sensor that is placed at a site on a patient, typically a fingertip, toe, forehead or earlobe, or in the case of a neonate, across a foot. The oximeter may pass light using a light source through blood perfused tissue and photoelectrically sense the absorption of light in the tissue. For example, the oximeter may measure the intensity of light that is received at the light sensor as a function of time. A signal representing light intensity versus time or a mathematical manipulation of this signal (e.g., a scaled version thereof, a log taken thereof, a scaled version of a log taken thereof, etc.) may be referred to as the photoplethysmograph (PPG) signal. In addition, the term “PPG signal,” as used herein, may also refer to an absorption signal (i.e., representing the amount of light absorbed by the tissue) or any suitable mathematical manipulation thereof. The light intensity or the amount of light absorbed may then be used to calculate the amount of the blood constituent (e.g., oxyhemoglobin) being measured as well as the pulse rate and when each individual pulse occurs.

The light passed through the tissue is selected to be of one or more wavelengths that are absorbed by the blood in an amount representative of the amount of the blood constituent present in the blood. The amount of light passed through the tissue varies in accordance with the changing amount of blood constituent in the tissue and the related light absorption. Red and infrared (IR) wavelengths may be used because it has been observed that highly oxygenated blood will absorb relatively less Red light and more IR light than blood with a lower oxygen saturation. By comparing the intensities of two wavelengths at different points in the pulse cycle, it is possible to estimate the blood oxygen saturation of hemoglobin in arterial blood.

When the measured blood parameter is the oxygen saturation of hemoglobin, a convenient starting point assumes a saturation calculation based at least in part on Lambert-Beer's law. The following notation will be used herein:

I(λ,t)=I₀(λ)exp(−(sβ₀(λ)+(1−s)βᵣ(λ))l(t)) (1)

where:
λ=wavelength;
t=time;
I=intensity of light detected;
I₀=intensity of light transmitted;
s=oxygen saturation;
β₀, βᵣ=empirically derived absorption coefficients; and
l(t)=a combination of concentration and path length from emitter to detector as a function of time.

The traditional approach measures light absorption at two wavelengths (e.g., Red and IR), and then calculates saturation by solving for the “ratio of ratios” as follows.

1. The natural logarithm of Eq. 1 is taken (“log” will be used to represent the natural logarithm) for IR and Red to yield

log I=log I₀−(sβ₀+(1−s)βᵣ)l. (2)

2. Eq. 2 is then differentiated with respect to time to yield

$$\frac{d log I}{d t} = - ( s {β}_{o} + ( 1 - s ) {β}_{r} ) \frac{d l}{d t} . \qquad ( 3 )$$

3. Eq. 3, evaluated at the Red wavelength λ_{R}, is divided by Eq. 3 evaluated at the IR wavelength λ_{IR} in accordance with

$$\frac{d log I ( {λ}_{R} ) / d t}{d log I ( {λ}_{IR} ) / d t} = \frac{s {β}_{o} ( {λ}_{R} ) + ( 1 - s ) {β}_{r} ( {λ}_{R} )}{s {β}_{o} ( {λ}_{IR} ) + ( 1 - s ) {β}_{r} ( {λ}_{IR} )} . \qquad ( 4 )$$

4. Solving for s yields

$$s = \frac{\frac{d log I ( {λ}_{IR} )}{d t} {β}_{r} ( {λ}_{R} ) - \frac{d log I ( {λ}_{R} )}{d t} {β}_{r} ( {λ}_{IR} )}{\begin{matrix}\frac{d log I ( {λ}_{R} )}{d t} ( {β}_{o} ( {λ}_{IR} ) - {β}_{r} ( {λ}_{IR} ) ) - \\ \frac{d log I ( {λ}_{IR} )}{d t} ( {β}_{o} ( {λ}_{R} ) - {β}_{r} ( {λ}_{R} ) )\end{matrix}} . \qquad ( 5 )$$

5. Note that, in discrete time, the following approximation can be made:

$$\frac{d log I ( λ , t )}{d t} ≃ log I ( λ , {t}_{2} ) - log I ( λ , {t}_{1} ) . \qquad ( 6 )$$

6. Rewriting Eq. 6 by observing that log A−log B=log(A/B) yields

$$\frac{d log I ( λ , t )}{d t} ≃ log ( \frac{I ( {t}_{2} , λ )}{I ( {t}_{1} , λ )} ) . \qquad ( 7 )$$

7. Thus, Eq. 4 can be expressed as

$$\frac{\frac{d log I ( {λ}_{R} )}{d t}}{\frac{d log I ( {λ}_{IR} )}{d t}} ≃ \frac{log ( \frac{I ( {t}_{1} , {λ}_{R} )}{I ( {t}_{2} , {λ}_{R} )} )}{log ( \frac{I ( {t}_{1} , {λ}_{IR} )}{I ( {t}_{2} , {λ}_{IR} )} )} = R , \qquad ( 8 )$$

where R represents the “ratio of ratios.”
8. Solving Eq. 4 for s using the relationship of Eq. 5 yields

$$s = \frac{{β}_{r} ( {λ}_{R} ) - R {β}_{r} ( {λ}_{IR} )}{R ( {β}_{o} ( {λ}_{IR} ) - {β}_{r} ( {λ}_{IR} ) ) - {β}_{o} ( {λ}_{R} ) + {β}_{r} ( {λ}_{R} )} . \qquad ( 9 )$$

9. From Eq. 8, R can be calculated using two points (e.g., PPG maximum and minimum), or a family of points. One method applies a family of points to a modified version of Eq. 8. Using the relationship

$$\frac{d log I}{d t} = \frac{\frac{d I}{d t}}{I} , \qquad ( 10 )$$

Eq. 8 becomes

$$\begin{matrix}\frac{\frac{d log I ( {λ}_{R} )}{d t}}{\frac{d log I ( {λ}_{IR} )}{d t}} ≃ \frac{\frac{I ( {t}_{2} , {λ}_{R} ) - I ( {t}_{1} , {λ}_{R} )}{I ( {t}_{1} , {λ}_{R} )}}{\frac{I ( {t}_{2} , {λ}_{IR} ) - I ( {t}_{1} , {λ}_{IR} )}{I ( {t}_{1} , {λ}_{IR} )}} \\ = \frac{[ I ( {t}_{2} , {λ}_{R} ) - I ( {t}_{1} , {λ}_{R} ) ] I ( {t}_{1} , {λ}_{R} )}{[ I ( {t}_{2} , {λ}_{IR} ) - I ( {t}_{1} , {λ}_{IR} ) ] I ( {t}_{1} , {λ}_{R} )} \\ = R ,\end{matrix} \qquad ( 11 )$$

which defines a cluster of points whose slope of y versus x will give R when

x=[I(t₂,λ_{IR})−I(t₁,λl_{IR})]I(t₁,λ_{R}), (12)

and

y=[I(t₂,λ_{R})−I(t₁,λ_{R})]I(t₁,λ_{IR}). (13)

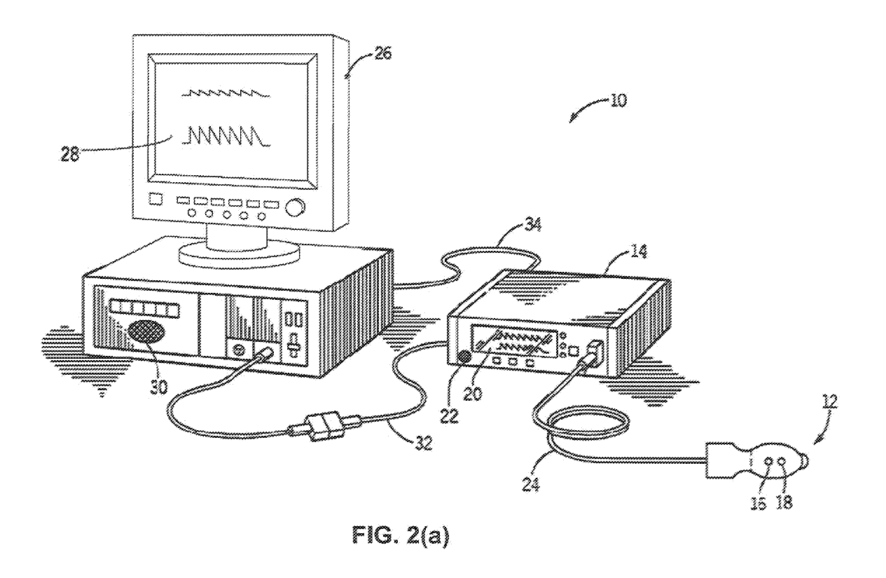

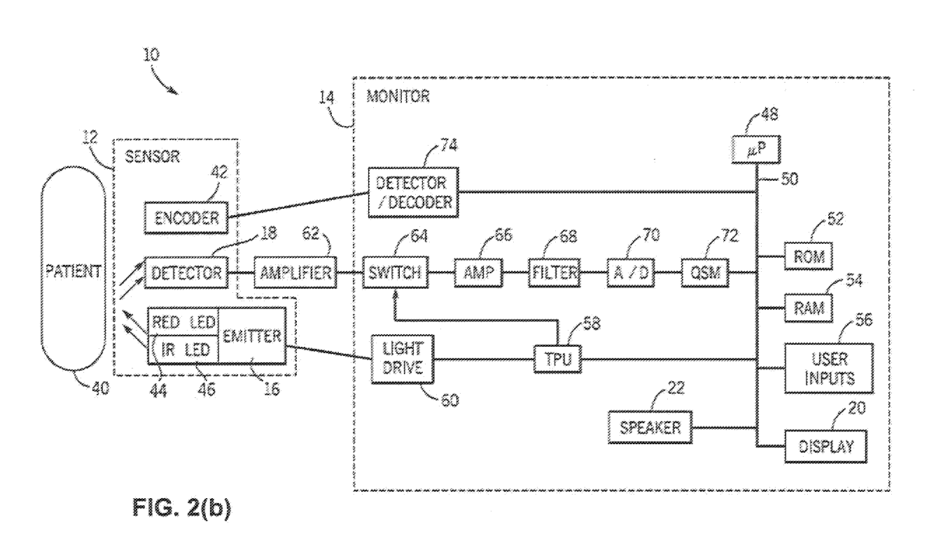

FIG. 2(a) is a perspective view of an embodiment of a patient monitoring system 10. In an embodiment, system 10 is implemented as part of a pulse oximetry system. System 10 may include a sensor 12 and a monitor 14. Sensor 12 may include an emitter 16 for emitting light at two or more wavelengths into a patient's tissue. A detector 18 may also be provided in sensor 12 for detecting the light originally from emitter 16 that emanates from the patient's tissue after passing through the tissue.

According to another embodiment and as will be described, system 10 may include a plurality of sensors forming a sensor array in lieu of single sensor 12. Each of the sensors of the sensor array may be a complementary metal oxide semiconductor (CMOS) sensor. Alternatively, each sensor of the array may be a charged coupled device (CCD) sensor. In another embodiment, the sensor array may be made up of a combination of CMOS and CCD sensors. A CCD sensor may comprise a photoactive region and a transmission region for receiving and transmitting data whereas the CMOS sensor may be made up of an integrated circuit having an array of pixel sensors. Each pixel may have a photodetector and an active amplifier.

According to an embodiment, emitter 16 and detector 18 may be on opposite sides of a digit such as a finger or toe, in which case the light that is emanating from the tissue has passed completely through the digit. In an embodiment, emitter 16 and detector 18 may be arranged so that light from emitter 16 penetrates the tissue and is reflected by the tissue into detector 18, such as a sensor designed to obtain pulse oximetry data from a patient's forehead.

In an embodiment, the sensor or sensor array may be connected to and draw its power from monitor 14 as shown. In another embodiment, the sensor may be wirelessly connected to monitor 14 and include its own battery or similar power supply (not shown). Monitor 14 may be configured to calculate physiological parameters based at least in part on data received from sensor 12 relating to light emission and detection. For example, monitor 14 may implement one or more of the least median squares techniques described herein to determine physiological information. In an alternative embodiment, the calculations may be performed on the monitoring device itself and the result of the oximetry reading may be passed to monitor 14. Further, monitor 14 may include a display 20 configured to display a patient's physiological parameters or information about the system. In the embodiment shown, monitor 14 may also include a speaker 22 to provide an audible sound that may be used in various other embodiments, such as sounding an audible alarm in the event that a patient's physiological parameters are not within a predefined normal range.

In an embodiment, sensor 12, or the sensor array, may be communicatively coupled to monitor 14 via a cable 24. However, in other embodiments, a wireless transmission device (not shown) or the like may be used instead of or in addition to cable 24.

In the illustrated embodiment, system 10 may also include a multi-parameter patient monitor 26. The monitor may be cathode ray tube type, a flat panel display (as shown) such as a liquid crystal display (LCD) or a plasma display, or any other type of monitor now known or later developed. Multi-parameter patient monitor 26 may be configured to calculate physiological parameters and to provide a display 28 for information from monitor 14 and from other medical monitoring devices or systems (not shown). For example, multi-parameter patient monitor 26 may be configured to display an estimate of a patient's blood oxygen saturation (referred to as an “SpO₂” measurement) generated by monitor 14, pulse rate information from monitor 14 and blood pressure from a blood pressure monitoring unit (not shown) on display 28.

Monitor 14 may be communicatively coupled to multi-parameter patient monitor 26 via a cable 32 or 34 that is coupled to a sensor input port or a digital communications port, respectively and/or may communicate wirelessly (not shown). In addition, monitor 14 and/or multi-parameter patient monitor 26 may be coupled to a network to enable the sharing of information with servers or other workstations (not shown). Monitor 14 may be powered by a battery (not shown) or by a conventional power source such as a wall outlet.

FIG. 2(b) is a block diagram of a patient monitoring system, such as patient monitoring system 10 of FIG. 2(a), which may be coupled to a patient 40 in accordance with an embodiment. Certain illustrative components of sensor 12 and monitor 14 are illustrated in FIG. 2(b). Sensor 12 may include emitter 16, detector 18, and encoder 42. In the embodiment shown, emitter 16 may be configured to emit one or more wavelengths of light (e.g., Red and/or IR) into a patient's tissue 40. Hence, emitter 16 may include a Red light emitting light source such as Red light emitting diode (LED) 44 and/or an IR light emitting light source such as IR LED 46 for emitting light into the patient's tissue 40 at the wavelengths used to calculate the patient's physiological parameters. In one embodiment, the Red wavelength may be between about 600 nm and about 700 nm, and the IR wavelength may be between about 800 nm and about 1000 nm. In embodiments in which a sensor array is used in place of a single sensor, each sensor may be configured to emit a single wavelength. For example, a first sensor may emit only a Red light while a second may emit only an IR light.

It will be understood that, as used herein, the term “light” may refer to energy produced by radiative sources and may include one or more of ultrasound, radio, microwave, millimeter wave, infrared, visible, ultraviolet, gamma ray or X-ray electromagnetic radiation. As used herein, light may also include any wavelength within the radio, microwave, infrared, visible, ultraviolet, or X-ray spectra. Any suitable wavelength of electromagnetic radiation may be appropriate for use with the present techniques. Detector 18 may be chosen to be specifically sensitive to the chosen targeted energy spectrum of the emitter 16.

In an embodiment, detector 18 may be configured to detect the intensity of light at the Red and IR wavelengths. Alternatively, each sensor in the array may be configured to detect an intensity of a single wavelength. In operation, light may enter detector 18 after passing through the patient's tissue 40. Detector 18 may convert the intensity of the received light into an electrical signal. The light intensity is directly related to the absorbance and/or reflectance of light in the tissue 40. That is, when more light at a certain wavelength is absorbed or reflected, less light of that wavelength is received from the tissue by the detector 18. After converting the received light to an electrical signal, detector 18 may send the signal to monitor 14, where physiological parameters may be calculated based on the absorption of the Red and IR wavelengths in the patient's tissue 40.

In an embodiment, encoder 42 may contain information about sensor 12, such as what type of sensor it is (e.g., whether the sensor is intended for placement on a forehead or digit) and the wavelength or wavelengths of light emitted by emitter 16. This information may be used by monitor 14 to select appropriate algorithms, lookup tables and/or calibration coefficients stored in monitor 14 for calculating the patient's physiological parameters.

Encoder 42 may contain information specific to patient 40, such as, for example, the patient's age, weight, and diagnosis. This information may allow monitor 14 to determine, for example, patient-specific threshold ranges in which the patient's physiological parameter measurements should fall and to enable or disable additional physiological parameter algorithms. Encoder 42 may, for instance, be a coded resistor which stores values corresponding to the type of sensor 12 or the type of each sensor in the sensor array, the wavelengths of light emitted by emitter 16 on each sensor of the sensor array, and/or the patient's characteristics. In another embodiment, encoder 42 may include a memory on which one or more of the following information may be stored for communication to monitor 14: the type of the sensor 12; the wavelengths of light emitted by emitter 16; the particular wavelength each sensor in the sensor array is monitoring; a signal threshold for each sensor in the sensor array; any other suitable information; or any combination thereof.

In an embodiment, signals from detector 18 and encoder 42 may be transmitted to monitor 14. In the embodiment shown, monitor 14 may include a general-purpose microprocessor 48 connected to an internal bus 50. Microprocessor 48 may be adapted to execute software, which may include an operating system and one or more applications, as part of performing the functions described herein. Also connected to bus 50 may be a read-only memory (ROM) 52, a random access memory (RAM) 54, user inputs 56, display 20, and speaker 22.

RAM 54 and ROM 52 are illustrated by way of example, and not limitation. Any suitable computer-readable media may be used in the system for data storage. Computer-readable media are capable of storing information that can be interpreted by microprocessor 48. This information may be data or may take the form of computer-executable instructions, such as software applications, that cause the microprocessor to perform certain functions and/or computer-implemented methods. Depending on the embodiment, such computer-readable media may include computer storage media and communication media. Computer storage media may include volatile and non-volatile, removable and non-removable media implemented in any method or technology for storage of information such as computer-readable instructions, data structures, program modules or other data. Computer storage media may include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by components of the system 10.

In the embodiment shown, a time processing unit (TPU) 58 may provide timing control signals to a light drive circuitry 60, which may control when emitter 16 is illuminated and multiplexed timing for the Red LED 44 and the IR LED 46. TPU 58 may also control the gating-in of signals from detector 18 through an amplifier 62 and a switching circuit 64. These signals are sampled at the proper time, depending upon which light source is illuminated. The received signal from detector 18 may be passed through an amplifier 66, a low pass filter 68, and an analog-to-digital converter 70. The digital data may then be stored in a queued serial module (QSM) 72 (or buffer) for later downloading to RAM 54 as QSM 72 fills up. In one embodiment, there may be multiple separate parallel paths having amplifier 66, filter 68, and A/D converter 70 for multiple light wavelengths or spectra received.

In an embodiment, microprocessor 48 may determine the patient's physiological parameters, such as SpO₂, using various techniques and/or look-up tables based on the value of the received signals and/or data corresponding to the light received by detector 18. For example, the slope of a best-fit line according to a least median squares error criterion between two physiological signals may be used to determine a patient's blood oxygen saturation from a look-up table of slope values. The two physiological signals may be Red and IR PPG signals, transformations of Red and IR PPG signals, or features of transformations of Red and IR PPG signals, as discussed in additional detail below.

Signals corresponding to information about patient 40, and particularly about the intensity of light emanating from a patient's tissue over time, may be transmitted from encoder 42 to a decoder 74. These signals may include, for example, encoded information relating to patient characteristics. Decoder 74 may translate these signals to enable the microprocessor to determine the thresholds based on algorithms or look-up tables stored in ROM 52. User inputs 56 may be used to enter information about the patient, such as age, weight, height, diagnosis, medications, treatments, and so forth. Such information may be stored in a suitable memory (e.g., RAM 54) and may allow monitor 14 to determine, for example, patient-specific threshold ranges in which the patient's physiological parameter measurements should fall and to enable or disable additional physiological parameter algorithms. In an embodiment, display 20 may exhibit a list of values which may generally apply to the patient, such as, for example, age ranges or medication families, which the user may select using user inputs 56.

The optical signal through the tissue can be degraded by noise, among other sources. One source of noise is ambient light that reaches the light detector. Another source of noise is electromagnetic coupling from other electronic instruments. Movement of the patient also introduces noise and affects the signal. For example, the contact between the detector and the skin, or the emitter and the skin, can be temporarily disrupted when movement causes either to move away from the skin. In addition, because blood is a fluid, it responds differently than the surrounding tissue to inertial effects, thus resulting in momentary changes in volume at the point at which a probe or sensor is attached.

Noise (e.g., from patient movement) can degrade a pulse oximetry signal relied upon by a physician without the physician's awareness. This is especially true if the monitoring of the patient is remote, the motion is too small to be observed, or the doctor is watching the instrument or other parts of the patient and not the sensor site. Processing physiological signals may involve operations that reduce the amount of noise present in the signals or otherwise identify noise components in order to prevent them from affecting measurements of physiological parameters derived from the physiological signals.

It will be understood that the present disclosure is applicable to any suitable signals and that PPG signals may be used merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In one embodiment, a physiological signal may be transformed using a continuous wavelet transform. Information derived from the transform of the physiological signal (i.e., in wavelet space) may be used to provide measurements of one or more physiological parameters.

The continuous wavelet transform of a signal x(t) in accordance with the present disclosure may be defined as

$$T ( a , b ) = \frac{1}{\sqrt{a}} {\int }_{- ∞}^{+ ∞} x ( t ) {ψ}^{*} ( \frac{t - b}{a} ) d t \qquad ( 14 )$$

where ψ*(t) is the complex conjugate of the wavelet function ψ(t), a is the dilation parameter of the wavelet and b is the location parameter of the wavelet. The transform given by Eq. 14 may be used to construct a representation of a signal on a transform surface. The transform may be regarded as a time-scale representation. Wavelets are composed of a range of frequencies, one of which may be denoted as the characteristic frequency of the wavelet, where the characteristic frequency associated with the wavelet is inversely proportional to the scale a. One example of a characteristic frequency is the dominant frequency. Each scale of a particular wavelet may have a different characteristic frequency. The underlying mathematical detail required for the implementation within a time-scale can be found, for example, in Paul S. Addison, The Illustrated Wavelet Transform Handbook (Taylor & Francis Group 2002), which is hereby incorporated by reference herein in its entirety.

The continuous wavelet transform decomposes a signal using wavelets, which are generally highly localized in time. The continuous wavelet transform may provide a higher resolution relative to discrete transforms, thus providing the ability to garner more information from signals than typical frequency transforms such as Fourier transforms (or any other spectral techniques) or discrete wavelet transforms. Continuous wavelet transforms allow for the use of a range of wavelets with scales spanning the scales of interest of a signal such that small scale signal components correlate well with the smaller scale wavelets and thus manifest at high energies at smaller scales in the transform. Likewise, large scale signal components correlate well with the larger scale wavelets and thus manifest at high energies at larger scales in the transform. Thus, components at different scales may be separated and extracted in the wavelet transform domain. Moreover, the use of a continuous range of wavelets in scale and time position allows for a higher resolution transform than is possible relative to discrete techniques.

In addition, transforms and operations that convert a signal or any other type of data into a spectral (i.e., frequency) domain necessarily create a series of frequency transform values in a two-dimensional coordinate system where the two dimensions may be frequency and, for example, amplitude. For example, any type of Fourier transform would generate such a two-dimensional spectrum. In contrast, wavelet transforms, such as continuous wavelet transforms, are required to be defined in a three-dimensional coordinate system and generate a surface with dimensions of time, scale and, for example, amplitude. Hence, operations performed in a spectral domain cannot be performed in the wavelet domain; instead the wavelet surface must be transformed into a spectrum (i.e., by performing an inverse wavelet transform to convert the wavelet surface into the time domain and then performing a spectral transform from the time domain). Conversely, operations performed in the wavelet domain cannot be performed in the spectral domain; instead a spectrum must first be transformed into a wavelet surface (i.e., by performing an inverse spectral transform to convert the spectral domain into the time domain and then performing a wavelet transform from the time domain). Nor does a cross-section of the three-dimensional wavelet surface along, for example, a particular point in time equate to a frequency spectrum upon which spectral-based techniques may be used. At least because wavelet space includes a time dimension, spectral techniques and wavelet techniques are not interchangeable. It will be understood that converting a system that relics on spectral domain processing to one that relies on wavelet space processing would require significant and fundamental modifications to the system in order to accommodate the wavelet space processing (e.g., to derive a representative energy value for a signal or part of a signal requires integrating twice, across time and scale, in the wavelet domain while, conversely, one integration across frequency is required to derive a representative energy value from a spectral domain). As a further example, to reconstruct a temporal signal requires integrating twice, across time and scale, in the wavelet domain while, conversely, one integration across frequency is required to derive a temporal signal from a spectral domain. It is well known in the art that, in addition to or as an alternative to amplitude, parameters such as energy density, modulus, and phase, among others, may all be generated using such transforms and that these parameters have distinctly different contexts and meanings when defined in a two-dimensional frequency coordinate system rather than a three-dimensional wavelet coordinate system. For example, the phase of a Fourier system is calculated with respect to a single origin for all frequencies while the phase for a wavelet system is unfolded into two dimensions with respect to a wavelet's location (often in time) and scale.

The energy density function of the wavelet transform, the scalogram, is defined as

S(a,b)=|T(a,b)|² (15)

where ‘| |’ is the modulus operator. The scalogram may be resealed for useful purposes. One common resealing is defined as

$${S}_{R} ( a , b ) = \frac{{\vert T ( a , b ) \vert}^{2}}{a} \qquad ( 16 )$$

and is useful for defining ridges in wavelet space when, for example, the Morlet wavelet is used. Ridges are defined as a locus of points of local maxima in the plane. A ridge associated with only the locus of points of local maxima in the plane is labeled a “maxima ridge.” Also included as a definition of a ridge are paths displaced from the locus of the local maxima. Any other suitable definition of a ridge may be employed in the techniques described herein.

For implementations requiring fast numerical computation, the wavelet transform may be expressed as an approximation using Fourier transforms. Pursuant to the convolution theorem, because the wavelet transform is the cross-correlation of the signal with the wavelet function, the wavelet transform may be approximated in terms of an inverse FFT of the product of the Fourier transform of the signal and the Fourier transform of the wavelet for each required a scale and a multiplication of the result by \sqrt{a}.

In the discussion of the technology which follows herein, the term “scalogram” may be taken to include all suitable forms of resealing including, but not limited to, the original unsealed wavelet representation, linear resealing, any power of the modulus of the wavelet transform, or any other suitable resealing. In addition, for purposes of clarity and conciseness, the term “scalogram” shall be taken to mean the wavelet transform, T(a,b) itself, or any part thereof. For example, the real part of the wavelet transform, the imaginary part of the wavelet transform, the phase of the wavelet transform, any other suitable part of the wavelet transform, or any combination thereof is intended to be conveyed by the term “scalogram.”

A scale, which may be interpreted as a representative temporal period, may be converted to a characteristic frequency of the wavelet function. The characteristic frequency associated with a wavelet of arbitrary a scale is given by

$$f = \frac{{f}_{c}}{a} , \qquad ( 17 )$$

where f_{c} is the characteristic frequency of the mother wavelet (i.e., at a=1) and becomes a scaling constant, and f is the representative or characteristic frequency for the wavelet at arbitrary scale a.

Any suitable wavelet function may be used in connection with the present disclosure. One of the most commonly used complex wavelets, the Morlet wavelet, is defined as

ψ(t)=π^{-1/4}(e^{i2πƒ}^{₀}^{t}−e^{-(2πƒ}^{₀}⁾^{²}^{/2})e^{-t}^{²}^{/2}, (18)

where ƒ₀ is the central frequency of the mother wavelet. The second term in the parentheses is known as the correction term, as it corrects for the non-zero mean of the complex sinusoid within the Gaussian window. In practice, it becomes negligible for values of ƒ₀>>0 and can be ignored, in which case, the Morlet wavelet can be written in a simpler form as

$$ψ ( t ) = \frac{1}{{π}^{1 / 4}} {e}^{i 2 π {f}_{0} t} {e}^{- {t}^{2} / 2} . \qquad ( 19 )$$

This wavelet is a complex wave within a scaled Gaussian envelope. While both definitions of the Morlet wavelet are included herein, the function of Eq. 19 is not strictly a wavelet as it has a non-zero mean (i.e., the zero frequency term of its corresponding energy spectrum is non-zero). However, it will be recognized by those skilled in the art that Eq. 19 may be used in practice with ƒ₀>>0 with minimal error and is included (as well as other similar near wavelet functions) in the definition of a wavelet herein. A more detailed overview of the underlying wavelet theory, including the definition of a wavelet function, can be found in the general literature. Discussed herein is how wavelet transform features may be extracted from the wavelet decomposition of signals. For example, wavelet decomposition of PPG signals may be used to provide clinically useful information.

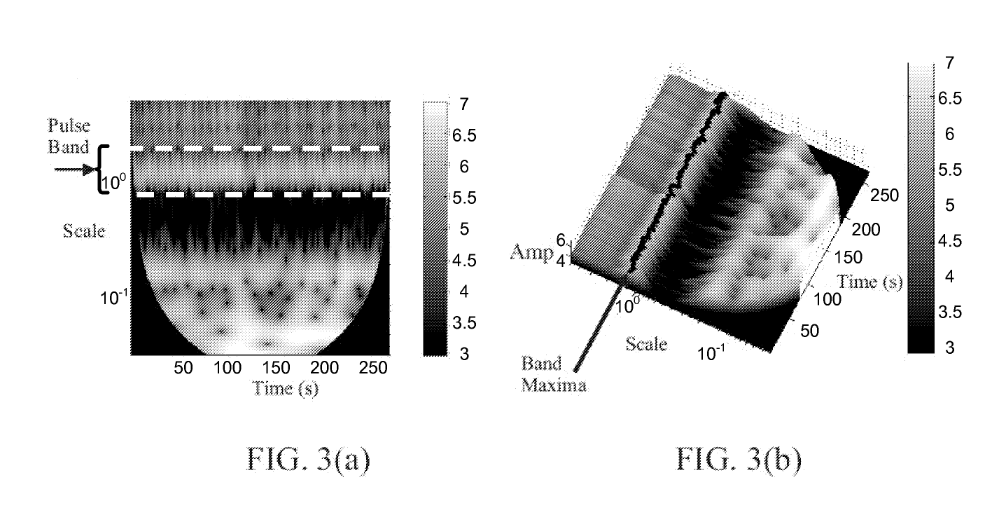

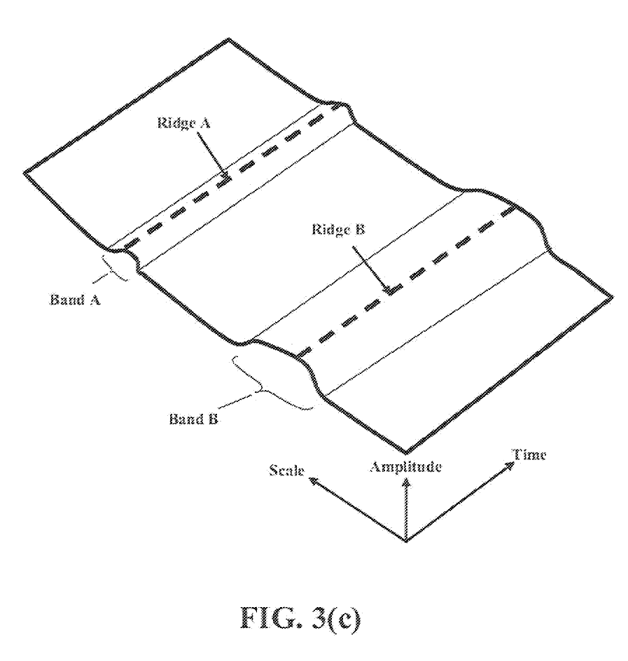

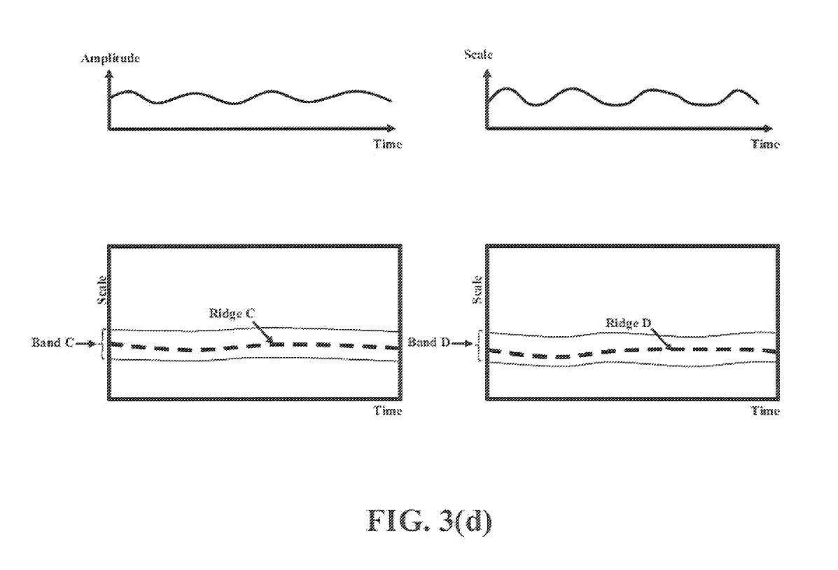

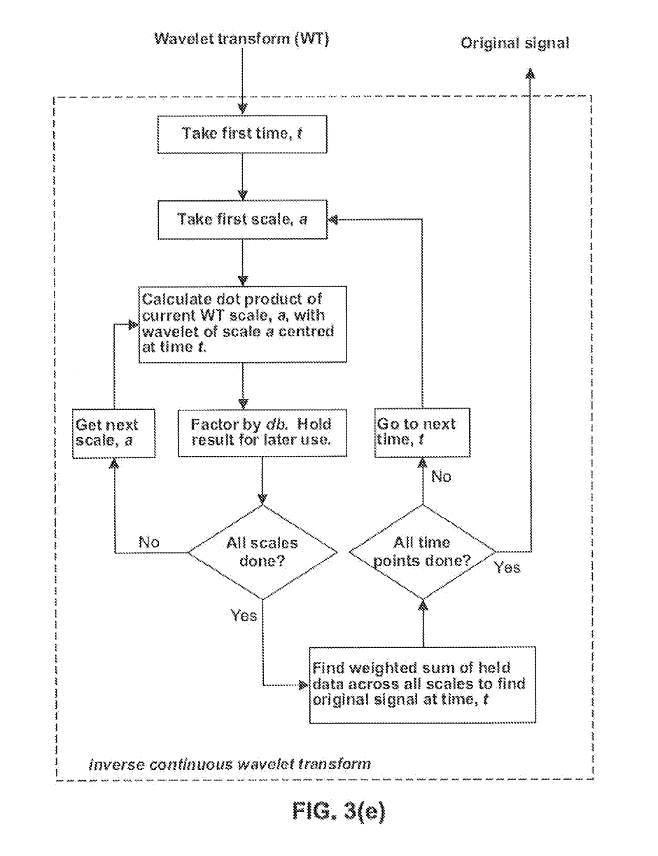

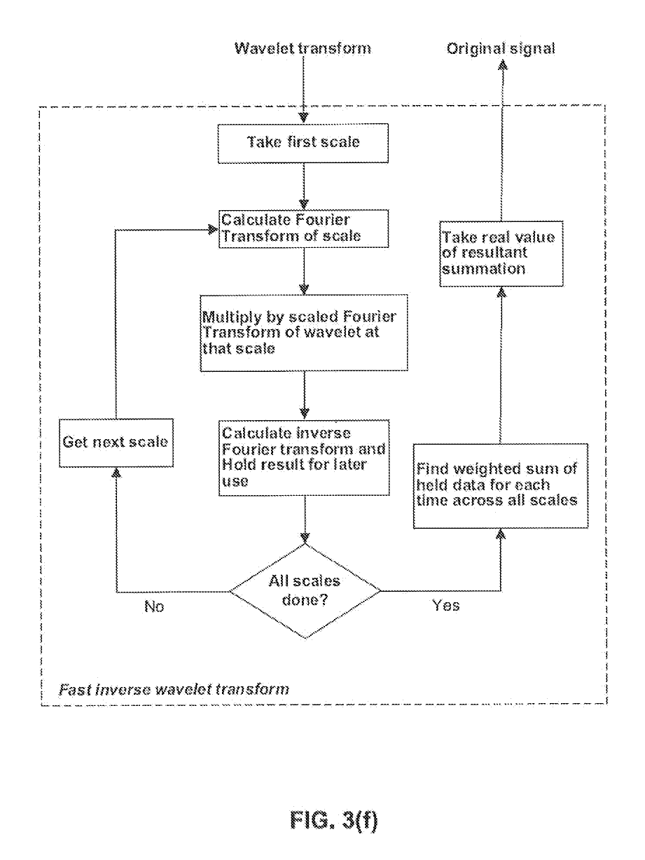

Pertinent repeating features in a signal give rise to a time-scale band in wavelet space or a resealed wavelet space. For example, the pulse component of a PPG signal produces a dominant band in wavelet space at or around the pulse frequency. FIGS. 3(a) and (b) show two views of an illustrative scalogram derived from a PPG signal, according to an embodiment. The figures show an example of the band caused by the pulse component in such a signal. The pulse band is located between the dashed lines in the plot of FIG. 3(a). The band is formed from a series of dominant coalescing features across the scalogram. This can be clearly seen as a raised band across the transform surface in FIG. 3(b) located within the region of scales indicated by the arrow in the plot (corresponding to 60 beats per minute). The maxima of this band with respect to scale is the ridge. The locus of the ridge is shown as a black curve on top of the band in FIG. 3(b). By employing a suitable resealing of the scalogram, such as that given in Eq. 16, the ridges found in wavelet space may be related to the instantaneous frequency of the signal. In this way, the pulse rate may be obtained from the PPG signal. Instead of resealing the scalogram, a suitable predefined relationship between the scale obtained from the ridge on the wavelet surface and the actual pulse rate may also be used to determine the pulse rate.

By mapping the time-scale coordinates of the pulse ridge onto the wavelet phase information gained through the wavelet transform, individual pulses may be captured. In this way, both times between individual pulses and the timing of components within each pulse may be monitored and used to detect heart beat anomalies, measure arterial system compliance, or perform any other suitable calculations or diagnostics. Alternative definitions of a ridge may be employed. Alternative relationships between the ridge and the pulse frequency of occurrence may be employed.

As discussed above, pertinent repeating features in the signal give rise to a time-scale band in wavelet space or a resealed wavelet space. For a periodic signal, this band remains at a constant scale in the time-scale plane. For many real signals, especially biological signals, the band may be non-stationary, and may vary in scale, amplitude, or both over time. FIG. 3(c) shows an illustrative schematic of a wavelet transform of a signal containing two pertinent components leading to two bands in the transform space, according to an embodiment. These bands are labeled band A and band B on the three-dimensional schematic of the wavelet surface. In an embodiment, a band ridge is defined as the locus of the peak values of these bands with respect to scale. For purposes of discussion, it may be assumed that band B contains the signal information of interest. Band B will be referred to as the “primary band.” In addition, it may be assumed that the system from which the signal originates, and from which the transform is subsequently derived, exhibits some form of coupling between the signal components in band A and band B. When noise or other erroneous features are present in the signal with similar spectral characteristics of the features of band B, then the information within band B can become ambiguous (i.e., obscured, fragmented or missing). In this case, the ridge of band A (referred to herein as “ridge A”) may be followed in wavelet space and extracted either as an amplitude signal or a scale signal which will be referred to as the “ridge amplitude perturbation” (RAP) signal and the “ridge scale perturbation” (RSP) signal, respectively. The RAP and RSP signals may be extracted by projecting the ridge onto the time-amplitude or time-scale planes, respectively. The top plots of FIG. 3(d) show a schematic of the RAP and RSP signals associated with ridge A in FIG. 3(c). Below these RAP and RSP signals are schematics of a further wavelet decomposition of these newly derived signals. This secondary wavelet decomposition allows for information in the region of band B in FIG. 3(c) to be made available as band C and band D. The ridges of bands C and D may serve as instantaneous time-scale characteristic measures of the signal components causing bands C and D. This technique, which will be referred to herein as secondary wavelet feature decoupling (SWFD), may allow information concerning the nature of the signal components associated with the underlying physical process causing the primary band B (FIG. 3(c)) to be extracted when band B itself is obscured in the presence of noise or other erroneous signal features.

In some instances, an inverse continuous wavelet transform may be desired, such as when modifications to a scalogram (or modifications to the coefficients of a transformed signal) have been made in order to, for example, remove artifacts, remove noise, combine bands, or any combination thereof. In one embodiment, there is an inverse continuous wavelet transform which allows the original signal to be recovered from its wavelet transform by integrating over all scales and locations, a and b, in accordance with

$$x ( t ) = \frac{1}{{C}_{g}} {\int }_{- ∞}^{∞} {\int }_{0}^{∞} T ( a , b ) \frac{1}{\sqrt{a}} ψ ( \frac{t - b}{a} ) \frac{ d a d b}{{a}^{2}} , \qquad ( 20 )$$

which may also be written as

$$x ( t ) = \frac{1}{{C}_{g}} {\int }_{- ∞}^{∞} {\int }_{0}^{∞} T ( a , b ) {ψ}_{a , b} ( t ) \frac{ d a d b}{{a}^{2}} , \qquad ( 21 )$$

where C_{g} is a scalar value known as the admissibility constant. It is wavelet-type dependent and may be calculated in accordance with

$${C}_{g} = {\int }_{0}^{∞} \frac{{\vert \hat{ψ} ( f ) \vert}^{2}}{f} d f . \qquad ( 22 )$$

FIG. 3(e) is a flow chart of illustrative steps that may be taken to perform an inverse continuous wavelet transform in accordance with the above discussion. An approximation to the inverse transform may be made by considering Eq. 20 to be a series of convolutions across scales. It shall be understood that there is no complex conjugate here, unlike for the cross correlations of the forward transform. As well as integrating over all of a and b for each time t, this equation may also take advantage of the convolution theorem which allows the inverse wavelet transform to be executed using a series of multiplications. FIG. 3(f) is a flow chart of illustrative steps that may be taken to perform an approximation of an inverse continuous wavelet transform. It will be understood that any other suitable technique for performing an inverse continuous wavelet transform may be used in accordance with the present disclosure.

The present disclosure relates to methods and systems for processing a signal using least median squares techniques to analyze signals in order to determine physiological information. It will be understood that the present disclosure is applicable to any suitable signals and that physiological signals may be used merely for illustrative purposes. Those skilled in the art will recognize that the present disclosure has wide applicability to other signals including, but not limited to other biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

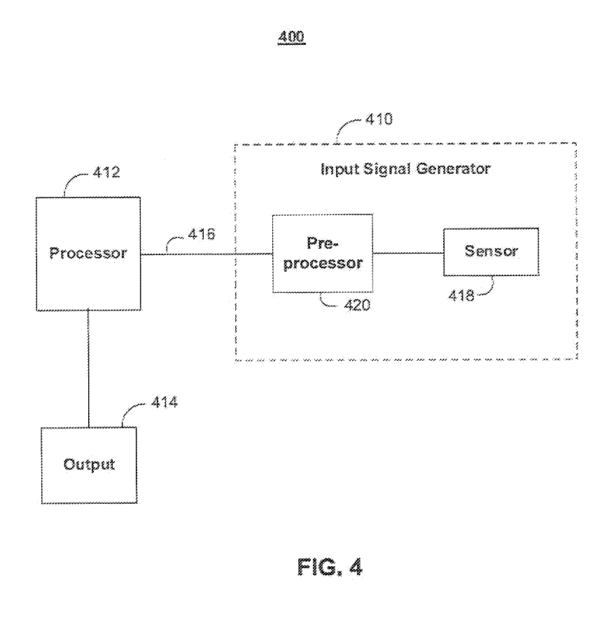

The methods for determining physiological information from signals described in this disclosure may be implemented on a multitude of different systems and apparatuses through the use of human-readable or machine-readable information. For example, the methods described herein may be implemented using machine-readable computer code and executed on a computer system that is capable of reading the computer code. An exemplary system that is capable of signal analysis is depicted in FIG. 4.

FIG. 4 is an illustrative signal processing system in accordance with an embodiment. In an embodiment, input signal generator 410 generates an input signal 416. As illustrated, input signal generator 410 may include pre-processor 420 coupled to sensor 418, which may provide as input signal 416 (e.g., a PPG signal). In an embodiment, pre-processor 420 may be an oximeter. It will be understood that input signal generator 410 may include any suitable signal source, signal generating data, signal generating equipment, or any combination thereof to produce signal 416. Signal 416 may be any suitable signal or signals, such as, for example, biosignals (e.g., electrocardiogram, electroencephalogram, electrogastrogram, electromyogram, heart rate signals, pathological sounds, ultrasound, or any other suitable biosignal), dynamic signals, non-destructive testing signals, condition monitoring signals, fluid signals, geophysical signals, astronomical signals, electrical signals, financial signals including financial indices, sound and speech signals, chemical signals, meteorological signals including climate signals, and/or any other suitable signal, and/or any combination thereof.

In an embodiment, signal 416 may be coupled to processor 412. Processor 412 may be any suitable software, firmware, and/or hardware, and/or combinations thereof, for processing signal 416. For example, processor 412 may include one or more hardware processors (e.g., integrated circuits), one or more software modules, computer-readable media such as memory, firmware, or any combination thereof. Processor 412 may, for example, be a computer or may be one or more chips (i.e., integrated circuits). Processor 412 may perform the calculations associated with the least median squares techniques of the present disclosure as well as the calculations associated with any suitable intermediate calculations, filtering, transformations, post-technique analysis, or any combination thereof. Processor 412 may perform any suitable signal processing of signal 416 to filter signal 416, such as any suitable band-pass filtering, adaptive filtering, closed-loop filtering, any other suitable filtering, and/or any combination thereof.

Processor 412 may be coupled to one or more memory devices (not shown) or incorporate one or more memory devices such as any suitable volatile memory device (e.g., RAM, registers, etc.), non-volatile memory device (e.g., ROM, EPROM, magnetic storage device, optical storage device, flash memory, etc.), or both. The memory may be used by processor 412 to, for example, store data corresponding to a least median squares technique applied to input signal 416, such as data representing an error curve. In one embodiment, data representing an error curve may be stored in RAM or memory internal to processor 412 as any suitable data structure. In an embodiment, data representing a scalogram may be stored in RAM or memory internal to processor 412 as any suitable data structure, such as a three-dimensional array that represents the scalogram as energy levels in a time-scale plane. Any other suitable data structure may be used to store data representing a scalogram. The memory may be used by processor 412, to, for example, store any data related to any of the calculations described herein, including determining a least median squares regression, calculating an error curve, combining multiple error curves, filtering a signal, determining a confidence, assessing a noise estimate, selecting a regression analysis, and performing a regression analysis, among others. This storage may take the form of any suitable data structure.

Processor 412 may be coupled to output 414. Output 414 may be any suitable output device such as one or more medical devices (e.g., a medical monitor that displays various physiological parameters, a medical alarm, or any other suitable medical device that either displays physiological parameters or uses the output of processor 412 as an input), one or more display devices (e.g., monitor, PDA, mobile phone, any other suitable display device, or any combination thereof), one or more audio devices, one or more memory devices (e.g., hard disk drive, flash memory, RAM, optical disk, any other suitable memory device, or any combination thereof), one or more printing devices, any other suitable output device, or any combination thereof.

It will be understood that system 400 may be incorporated into system 10 (FIGS. 2(a) and 2(b)) in which, for example, input signal generator 410 may be implemented as parts of sensor 12 and monitor 14 and processor 412 may be implemented as part of monitor 14. In some embodiments, portions of system 400 may be configured to be portable. For example, all or a part of system 400 may be embedded in a small, compact object carried with or attached to the patient (e.g., a watch, other piece of jewelry, or cellular telephone). In such embodiments, a wireless transceiver (not shown) may also be included in system 400 to enable wireless communication with other components of system 10. As such, system 10 may be part of a fully portable and continuous patient monitoring solution.

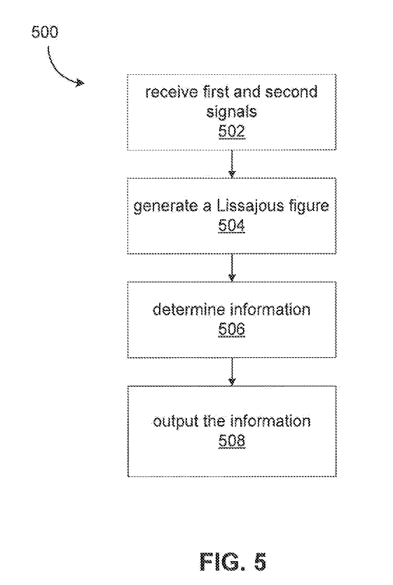

FIG. 5 is a flow chart 500 of illustrative steps involved in determining information using a least median squares technique in accordance with an embodiment. The steps of flow chart 500 may be performed by processor 412, or may be performed by any suitable processing device communicatively coupled to monitor 14. The steps of flow chart 500 may be performed by a digital processing device, or implemented in analog hardware. It will be noted that the steps of flow chart 500 may be performed in any suitable order, and certain steps may be omitted entirely.

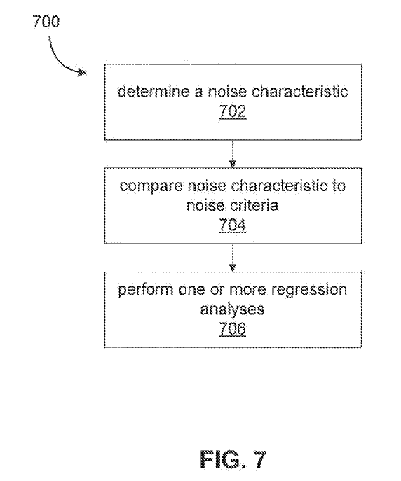

The steps of flow chart 500 may be executed over a sliding window of a signal. For example, the steps of flow chart 500 may involve analyzing the previous N samples of a signal, or the signal received over the previous T units of time. The length of the sliding window over which the steps of flow chart 500 is executed may be fixed or dynamic. In an embodiment, the length of the sliding window may be based at least in part on the noise content of a signal. For example, the length of the sliding window may increase with increasing noise, as may be determined by a noise assessment. Examples of illustrative noise assessment techniques are described in detail below with reference to step 702 of flow chart 700 of FIG. 7.

At step 502, first and second signals may be received. A signal (e.g., a PPG signal) may be received from any suitable source (e.g., patient 40) using any suitable technique. A received signal may be generated by sensor unit 12, which may itself include any of the number of physiological sensors described herein. A received signal may be signal 416, which may be generated by a pre-processor 420 coupled between processor 412 and sensing device 418. A single received signal may include multiple signals (e.g., first and second signals), for example, in the form of a multi-dimensional vector signal or a frequency- or time-multiplexed signal. Additionally, a signal received at step 502 may be a derived signal generated internally to processor 412. Accordingly, a received signal may be based at least in part on a filtered version of a signal 416, or a combination of multiple signals. For example, a received signal may be a ratio of two signals. A received signal may be a transformation of a signal 416, such as a continuous wavelet transformation of a signal 416. A received signal may be based at least in part on past values of a signal, such as signal 416, which may be retrieved by processor 412 from a memory such as a buffer memory or RAM 54.

In an embodiment, a signal received at step 502 may be a PPG signal which may be obtained from sensor 12 that may be coupled to patient 40. A PPG signal may be obtained from input signal generator 410, which may include pre-processor 420 coupled to sensor 418, which may provide as input signal 416 a PPG signal. In an embodiment, a PPG signal may be obtained from patient 40 using sensor 12 or input signal generator 410 in real time. In an embodiment, a PPG signal may have been stored in ROM 52, RAM 52, and/or QSM 72 (FIG. 2(b)) in the past and may be accessed by microprocessor 48 within monitor 14 to be processed. One or more PPG signals may be received as input signal 416 and may include one or more of a Red PPG signal and an IR PPG signal. In an embodiment, a first signal may be a Red PPG signal, and a second signal may be an IR PPG signal. In an embodiment, a first and second signal may be different types of signals (e.g., a blood pressure signal and a pulse rate signal). In an embodiment, a first and second signal may be obtained by first and second sensors located at approximately the same body site. In an embodiment, first and second signals may be obtained by first and second sensors located at different body sites.

In an embodiment, more than two signals may be received at step 502. For example, PPG signals at three or more frequencies may be obtained at step 502. It will be noted that the steps of flow chart 500 may be applied to any number of received signals by application of the techniques described herein.

In an embodiment, one or more of the first and second signals received at step 502 may be transformed. A transformation may occur in conjunction with the receiving at step 502, or after the signals are received at step 502. In an embodiment, processor 412 may transform the signal into any suitable domain, for example, a Fourier, wavelet, spectral, scale, time, time-spectral, time-scale domain, or any transform space. This transformation may be performed by any one or more of the transformation techniques described herein, including a continuous wavelet transformation. This transformation may be performed by any suitable processing device, such as processor 412 and/or microprocessor 48, which may each be a general-purpose computing device or a specialized processor. The transformation may also be performed by a separate, dedicated device. Processor 412 may further transform the original and/or transformed signals into any suitable domain. In an embodiment, a transformation may be based at least in part on a continuous wavelet transformation. For example, a PPG signal may be transformed using a continuous wavelet transform as described above with reference to FIG. 3(c). In an embodiment, a transformation may include performing a continuous wavelet transform for one or more PPG signals received, for example, at step 502, including an IR PPG signal, a Red PPG signal, or any combination of signals.

In an embodiment, a scalogram may be generated as part of a transformation of one or more of the signals received at step 502. A scalogram may be generated by any of the techniques described herein, including those described above with reference to FIGS. 3(a) and 3(b). For example, processor 412 or microprocessor 48 may perform the calculations associated with the continuous wavelet transform of a signal and the derivation of the scalogram. In an embodiment, a scalogram may be based on any one or more features of a transformed signal. For example, a scalogram may represent the real part of a transformed signal, the imaginary part of a transformed signal, the modulus of a transformed signal, any other suitable feature of the transformed signal, or any combination thereof. In an embodiment, one or more of the signals received at step 502 may represent a scalogram of a signal. For example, a first received signal may be a continuous wavelet transformation of a Red PPG signal, and a second received signal may be a continuous wavelet transformation of an IR PPG signal.

In an embodiment, pre- or post-processing techniques may be applied to one or more of the first and second signals received at step 502. These techniques may include any one or more of the following: compressing, multiplexing, modulating, up-sampling, down-sampling, smoothing, taking a median or other statistic of the received signal, removing erroneous regions of the received signal, or any combination thereof. In an embodiment, a normalization step is performed which divides the magnitude of the received signal by a value. This value may be based on at least one of the maximum of the received signal, the minimum of the received signal and the mean of the received signal.

In an embodiment, one or more of the first and second signals received at step 502 may be filtered using any suitable filtering technique. For example, a signal received at sensor 12 may be filtered by a low pass filter 68 prior to undergoing additional processing at microprocessor 48 within patient monitoring system 10. The low pass filter 68 may selectively remove frequencies that may later be ignored by a transformation or other processing step, which may advantageously reduce computational time and memory requirements. In an embodiment, a signal received at step 502 may be high or band pass filtered to remove low frequencies. Such a filter may be, for example, a derivative filter. In an embodiment, a signal received at step 502 may be filtered to remove a DC component. In an embodiment, a signal received at step 502 may be normalized by dividing the signal by a DC component. In an embodiment, the cutoff frequencies of a filter may be chosen based on the frequency response of the hardware platform underlying patient monitoring system 10.

Different operations, which may include transformation, processing and/or filtering techniques, may be applied to any one or more of the first and second signals received at step 502 and/or any components of a multi-component signal. For example, different operations may be applied to a Red PPG signal and an IR PPG signal. An operation may be applied to a portion or portions of a received signal. An operation may be broken into one or more stages performed by one or more devices within signal processing system 400 (which may itself be a part of patient monitoring system 10). For example, a filtering technique may be applied by input signal generator 410 prior to passing the resulting input signal 416 to processor 412, where it may undergo a transformation. Embodiments of the steps of flow chart 500 include any of the operations described herein performed in any suitable order.

Any number of computational and/or optimization techniques may be performed in conjunction with the techniques described herein. For example, any known information regarding the physiological status of the patient may be stored in memory (e.g., ROM 52 or RAM 54). Such known information may be keyed to the characteristics of the patient, which may be input via user inputs 56 and used by monitor 14 to, for example, query a lookup table and retrieve the appropriate information. Additionally, any of the techniques described herein may be optimized for a particular hardware implementation, which may involve implementing any one or more of a pipelining protocol, a distributed algorithm, a memory management algorithm, or any suitable optimization technique.

At step 504, a Lissajous figure may be generated based at least in part on the first and second signals received at step 502. A Lissajous figure may include a comparison between the first and second signals. The comparison may take the form of a plot in two or more dimensions, with the first signal plotted on a first axis and the second signal plotted on a second axis. In an embodiment, the Lissajous figure generated at step 504 may be generated in three or more dimensions. Each of the axes in a Lissajous figure generated at step 504 may represent one or more of a received signal (e.g., the first and/or second signals received at step 502), a transformation of a received signal, a mathematical manipulation of a received signal, a signal derived from a received signal, a reference signal, or any combination thereof. In an embodiment, a Lissajous figure may be based at least in part on one or more PPG signals taken from a patient. In an embodiment, a Lissajous figure may be based on a Red PPG signal and an IR PPG signal, and may include a two-dimensional plot in which the Red PPG signal is represented by a first axis and the IR PPG signal is represented by a second axis.

In an embodiment, a Lissajous figure may be based at least in part on transformations of one or more PPG signals taken from a patient. In an embodiment, a Lissajous figure may be based on a feature of a transformation of a Red PPG signal and a feature of a transformation of an IR PPG signal. For example, the feature of a transformation of a signal may be the set of waveform values of a scalogram representation of the signal at a particular scale. Such a set of waveform values may be calculated for each of a Red scalogram and an IR scalogram, and for a plurality of scales. For each scale, the set of calculated waveform values for the Red scalogram may be plotted against the set of calculated waveform values for the IR scalogram in a two-dimensional plot. Multiple such two-dimensional plots (each corresponding to a particular scale) may be arranged along a scale axis to form a three-dimensional plot. This three-dimensional plot may serve as a three-dimensional Lissajous figure to which the techniques disclosed herein may be applied. Additional Lissajous figures may be derived from such a three-dimensional Lissajous figure. For example, a two-dimensional Lissajous figure may be derived by projecting a three-dimensional Lissajous figure onto a two-dimensional plane in which one dimension represents a Red PPG signal and the second dimension reprepresents an IR PPG signal. The techniques disclosed herein may be applied to this two-dimensional Lissajous figure.

In an embodiment, generating a Lissajous figure at step 504 may include generating one or more summary statistics representing a relationship between the first and second signals. For example, generating a Lissajous figure may include determining a best-fit curve, performing a principal components analysis, analyzing a trajectory, or any combination thereof. In an embodiment, a Lissajous figure may be displayed for a user in any manner described herein, including via displays 20 and 28. A Lissajous figure may also be recorded to a memory device (e.g., RAM 54 or a remote storage device) or a physical medium such as a print-out.

Once a Lissajous figure is generated at step 504, information may be determined at step 506 from at least the Lissajous figure based at least in part on a least median squares technique. In an embodiment, the information may be physiological information derived from a comparison of oximetry signals, such as a Red PPG signal and an IR PPG signal, among other signals. The physiological information determined at step 506 may be quantitative or qualitative, and may be the result of applying a predictive model such as a neural network to the Lissajous figure (discussed in additional detail below). For example, the physiological information may be at least one of an identification of a medical condition of the patient and a current physiological measurement.

In an embodiment, the information determined at step 506 may be a blood oxygen saturation measurement. In such an embodiment, determining information from a Lissajous figure based at least in part on a least median squares technique may include determining the slope of a best-fit line between two physiological signals using a least median squares error criterion. The two physiological signals may be Red and IR PPG signals, transformations of Red and IR PPG signals, or features of transformations of Red and IR PPG signals, such as a ridge of a transformation. In an embodiment, a patient's blood oxygen saturation may be calculated from the determined slope by using a look-up table of slope values (stored, for example, in ROM 52). Additional blood oxygen saturation determination techniques to which the least median squares techniques described herein may be applied are described in Addison et al., U.S. application Ser. No. 10/547,430, filed Feb. 27, 2004, entitled “METHOD OF ANALYZING AND PROCESSING SIGNALS,” which is incorporated by reference herein in its entirety.

In an embodiment, a least median squares technique may include determining one or more parameters that characterize a relationship between the signals represented in the Lissajous figure. Such parameters may define linear and/or non-linear relationships between the signals and may be determined by employing a least median squares error metric.

In an embodiment, the least median squares technique may include determining a least median squares regression curve within the Lissajous figure generated at step 504. For example, a Lissajous figure generated at step 504 may include a comparison of a Red PPG signal and an IR PPG signal, a feature of a transformation of a Red PPG signal and a transformation of an IR PPG signal, or any combination thereof. In such an embodiment, determining a least median squares regression curve may include determining values of the parameters a and b that minimize the quantity

median{(y₁−(ax₁+b))²,(y₂−(ax₂+b))², . . . ,(yₙ−(axₙ+b))²}, (23)

in which xᵢ represents the ith IR PPG data value and yᵢ represents the ith Red PPG data value. The parameters a and b obtained by minimizing the expression of Eq. 23 define a least median squares regression line relating the Red PPG data and the IR PPG data. Several techniques may be used for determining approximate and/or exact values of the parameters a and b. For example, techniques such as PROGRESS, techniques based on random sampling, and others may be used. Additional techniques for determining one or more of the parameters a and b are described in detail below.

In an embodiment, determining a least median squares regression curve may include determining a value of the parameter a that minimizes the quantity

median{(y₁−(ax₁))²,(y₂−(ax₂))², . . . ,(yₙ−(axₙ))²}, (24)

in which xᵢ represents the ith IR PPG data value and yᵢ represents the ith Red PPG data value. In this embodiment, the least median squares regression line is constrained to pass through the origin of the Red and IR PPG data axes. Any of the above-described techniques for determining minimizing parameters may be used to determine the value of a in such an embodiment. Additional techniques may also be used in such an embodiment, instead of or in conjunction with any of the above-described techniques. For example, specialized techniques may be used for determining the parameter a of a least median squares regression line constrained to pass through the origin.

In an embodiment, determining a least median squares regression curve may include determining values of the components of the parameter vector \vec{a} that minimize the quantity

median{(y₁−ƒ(x₁;\vec{a}))²,(y₂−ƒ(x₂;\vec{a}))², . . . ,(yₙ−ƒ(xₙ;\vec{a}))²}, (25)

in which xᵢ represents the ith IR PPG data value, yᵢ represents the ith Red PPG data value, and ƒ represents a function parameterized by the parameter vector \vec{a}. The function ƒ may take any suitable form, and may be a linear, affine, or non-linear function. Any of the above-described techniques for determining minimizing parameters may be used to determine the values of the components of \vec{a} in this embodiment.

In an embodiment, the least median squares technique may include determining a least median squares regression surface within the Lissajous figure generated at step 504. For example, a Lissajous figure generated at step 504 may include a comparison of three or more PPG signals, or transforms of one or more of three or more PPG signals, in three or more dimensions. In such an embodiment, a least median squares regression surface may be determined by generalizing the expressions provided, for example, in Eq. 25, to the three or more dimensions of the Lissajous figure.

In an embodiment, one or more of the parameters may be chosen from a finite set of values. This finite set of values may represent a physiological relevant range, and may be determined empirically and/or via predictive models. For example, the slope of a least median squares regression line relating Red PPG data and IR PPG data to determine a patient's blood oxygen saturation may fall in the range of 0.2 to 3 in many clinical applications, which may correspond to a SpO₂ range of approximately 20-100%, though other ranges may be used The finite set of values may be predetermined and stored, for example, in ROM 52 or RAM 54. The finite set of values may depend on one or more characteristics of a patient, such as a known health status. Patient characteristics may be input to a patient monitoring system such as patient monitoring system 10 (e.g., via user inputs 56) or may be determined by patient monitoring system 10 itself. The finite set of values may be fixed or may be dynamically adjusted. In an embodiment, the finite set of values may be based on previous determinations of physiological information. For example, if a previous iteration of a information determination technique (e.g., as illustrated in flow chart 500) has yielded a value of X for the parameter a (e.g., a slope of a best-fit line), the finite set of values for a subsequent determination of parameter a may be centered at the value X. The finite set of values may depend on a measure of noise in a signal, a measure of variability in a signal, or any combination thereof. In an embodiment, a signal with low noise and/or low variability may use a narrower range of values than a signal with relatively higher noise and/or variability. In an embodiment, the number of values in the finite set of values may vary depending upon a noise measure, a variability measure, a previous information determination, or any combination thereof.

In an embodiment, the number of values in the finite set of values may depend on an intended use and/or a performance requirement of the device. For example, a device intended to be used in low power settings (or for low acuity applications, or designed for low cost) may use a smaller set of values, which may result in a lower resolution of the output parameters. For example, the number of values in the finite set of values may be chosen such that an oximeter device may achieve a 2 or 3% SpO₂ resolution. An oximetry device with higher power and/or higher acuity may use a larger set of finite values to result in a higher SpO₂ resolution, such as a decimal percentage resolution. In an embodiment, a user may be able to select the number of values in the finite set of values. In an embodiment, the user may be able to specify one or more of a desired acuity, a desired power consumption, and a desired performance requirement, in response to which the finite set of values may be determined and set by the device. In an embodiment, a device may switch from a nominal set of values to a different set of values in response to a change in operating conditions (e.g., to conserve power when operating on a battery).

In embodiments which employ a finite set of values as described above, the value of a parameter may be selected in any of a number of ways. In an embodiment, a numerical or analytical technique may be applied to determine the value of one or more parameters from the finite set of values, such as any of the numerical and analytical techniques described above. In an embodiment, each of the finite set of values is substituted into an error expression (such as Eq. 25) and an associated least median squares error may be calculated. In such an embodiment, the parameter may be chosen to be the value which has the smallest associated least median squares error.

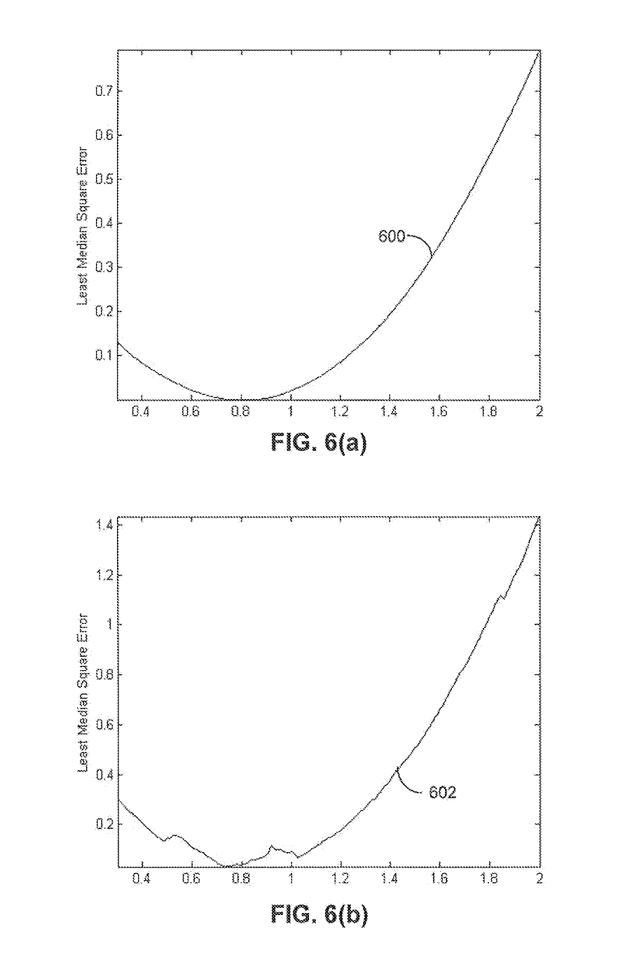

In an embodiment, the least median squares technique used to determine information at step 506 may include generating an error curve based at least in part on a least median squares error metric. Such embodiments are discussed in detail below with reference to FIGS. 6(a) and 6(b).

In an embodiment, a predictive computational model may be used to determine information at step 506. For example, a predictive computational model may determine estimates of a patient's current physiological status and prognosis as part of the determined information. A predictive computational model, executed, for example, by processor 412, may be based in part on at least one of the following data sources: the received signal (e.g., input signal 416); additional signals (e.g., physiological and/or environmental signals); patient characteristics; historical data of the patient or other patients; and computational or statistical models of physiological processes. Processor 412 may retrieve any of these data sources from memory such as ROM 52 or RAM 54, from an external memory device, or from a remote memory device. The structure of a predictive computational model may, for example, be based on any of the following models: a neural network, a Bayesian classifier, and a clustering algorithm. In an embodiment, processor 412 may develop a predictive neural network for noise assessment based at least in part on historical data from the given patient and/or other patients. In some embodiments, processor 412 may implement the predictive computational model as a hypothesis test. Processor 412 may continually refine or augment the predictive computational model as new data and/or signals are received. The predictive model may also be refined based on feedback from the patient or care provider received through user inputs 56. Other predictive frameworks may include rule-based systems and adaptive rule-based systems such as propositional logic, predicate calculus, modal logic, non-monotonic logic and fuzzy logic.

At step 508, the information determined at step 506 may be output to an output device. Information may be output through a graphical representation, quantitative representation, qualitative representation, or combination of representations via output 414 and may be controlled by processor 412. Output 414 may transmit physiological information by any means and through any format useful for informing a patient and a care provider of a patient status and may involve recording the physiological information to a storage medium. Quantitative and/or qualitative information provided by output 414 may be displayed on a display, for example, on display 28. A graphical representation may be displayed in one, two, or more dimensions and may be fixed or change with time. A graphical representation may be further enhanced by changes in color, pattern, or any other visual representation. Output 414 may communicate the information by performing at least one of the following: presenting a screen on a display; presenting a message on a display; producing a tone or sound; changing a color of a display or a light source; producing a vibration; and sending an electronic message. Output 414 may perform any of these actions in a device close to a patient, or at a mobile or remote monitoring device as described previously. In an embodiment, output 414 produces a continuous tone or beeping whose frequency changes in response to changes in a process of interest, such as a physiological process. In an embodiment, output 414 produces a colored or flashing light which changes in response to changes in a physiological process of interest.

After or during the output of physiological information at step 508, the steps of flow chart 500 may begin again. New first and second signals may be received, or the physiological information determination may continue on another portion of one or more of the first and second received signal(s). In an embodiment, processor 412 may continuously or periodically perform steps 502-508 and update the information (e.g., as the patient's condition changes). The process may repeat indefinitely, until there is a command to stop the monitoring and/or until some detected event occurs that is designated to halt the monitoring process. For example, it may be desirable to halt a monitoring process when a detected noise has become too great, or when a patient has undergone a change in condition that can no longer be sufficiently well-monitored in a current configuration. In an embodiment, processor 412 performs the steps of flow chart 500 at a prompt from a care provider via user inputs 56. In an embodiment, processor 412 performs the steps of flow chart 500 at intervals that change according to patient status. For example, the steps of flow chart 500 will be performed more often when a patient is undergoing rapid changes in physiological condition, and will be performed less often as the patient's condition stabilizes.

Additional illustrative embodiments of least median squares techniques will now be discussed. As described above, in an embodiment, a least median squares technique used to determination information at step 506 may include generating an error curve based at least in part on a least median squares error metric. In an embodiment, an error curve may relate each of a possible set of parameter values and its associated least median squares error. Illustrative examples of error curves are depicted in FIGS. 6(a) and 6(b) and embodiments employing error curves are discussed in detail below.

FIGS. 6(a) and 6(b) depict illustrative error curves using a least median squares error metric. In FIG. 6(a), error curve 600 indicates the least median squares errors (plotted on the y-axis) associated with different possible values of a parameter (plotted on the x-axis) in a least median squares regression, such as parameter a of Eq. 24. These possible values may be the finite set of values discussed above with reference to step 506 of flow chart 500 of FIG. 5. In an embodiment, the parameter may be the slope of a line relating Red and IR PPG signals measured in a pulse oximetry system (i.e., the ratio between the Red measurements and the IR measurements). In an embodiment, the parameter may be the slope of a line relating a feature of a transformation of a Red PPG signal and a feature of a transformation of an IR PPG signal. Although FIG. 6(a) depicts error curve 600 over a single dimension (representing a single parameter), it will be understood that any of the techniques described herein are readily applied to regressions and error curves over two or more parameters. Error curve 600 has a minimum error value of approximately zero at parameter value 0.8, indicating that 0.8 may be an appropriate value to select for the parameter. Error curve 600 may consist of discrete points and, in an embodiment, may be treated as continuous by an interpolation operation (e.g., sample-and-hold or linear interpolation), a curve-fitting operation (e.g., fitting a parabola or other suitable curve to the least median squares error data), or any combination thereof.

Although error curve 600 as illustrated exhibits a unique minimum value, error curves may exhibit multiple minima and maxima. In such cases, one or more of the parameter values associated with minima (or parameter values proximal to a minimum) may be selected based on additional information such as physiological constraints, previously selected minima, statistical models of parameter distributions, or any other suitable information. An error curve may also be filtered or manipulated, which may modify the location and/or magnitude of maxima and/or minima, as discussed below.

FIG. 6(b) depicts a second illustrative error curve 602. In comparison to error curve 600, error curve 602 exhibits additional local peaks and valleys. Such “roughness” may arise from noise in a patient monitoring system (e.g., as may be detected at sensor 12 and as may arise from hardware noise in low perfusion conditions), changes in a patient status (e.g., a change in blood oxygen saturation which may affect Red and IR PPG data signals), or any other source of signal variability. In an embodiment, an error curve may be modified as part of a least median squares technique. For example, an error curve such as error curve 602 may be smoothed and the minimum of the smoothed curve may be used to determine the value of an associated parameter. In an embodiment, a filtering operation may be applied to an error curve, which may include one or more of a low-pass filter, a moving average filter, any suitable smoothing filter, or any combination thereof. In an embodiment, a filter may be chosen to reduce interfering noise at a particular frequency or set of frequencies. In an embodiment, a noise reduction operation, such as a filtering operation, may be applied to reduce interfering noise occurring over a window or windows in a time-scale representation of a signal derived, for example, by applying a continuous wavelet transformation. As used herein, the term “error curve” may refer to an error curve or any suitable filtering and/or manipulation of an error curve. Additional examples of suitable filtering and/or manipulation operations are discussed below. For example, an error curve may represent the average of multiple error curves taken at different intervals. A weighted average may be used, with higher weight given to higher confidence curves. Confidence may be determined by any number of techniques (e.g., the techniques described below).

In an embodiment, a confidence may be determined based at least in part on an error curve based on a least median squares error metric. A confidence determination may indicate the degree to which a parameter determination is to be relied upon in the determination of information (e.g., the information determined at step 506 of FIG. 5). In an embodiment, a “smoother” error curve (such as error curve 600) may be associated with a higher confidence than a “rougher” error curve (such as error curve 602). Relative “smoothness” and “roughness” of an error curve may be determined in any of a number of ways, including examining zero crossings of a derivative of the error curve, measuring deviations from a best-fit curve, measuring deviations from a predetermined ideal error curve, performing a frequency analysis, any other suitable technique, or any combination thereof.

In an embodiment, a confidence determination may be based on the value of the minimum of the error curve. For example, an error curve with a minimum error value closer to zero may be associated with higher confidence than an error curve with a minimum error value further from zero.

In an embodiment, a confidence determination may be based on a measure of the concavity of an error curve. A “deeper” (i.e., more concave) error curve may be associated with a higher confidence than a “shallower” (i.e., less concave) error curve. In an embodiment, a concavity measure may be based on a comparison between a minimum value of an error curve and a maximum value of the error curve. For example, this comparison may include an absolute difference between a minimum value and a maximum value of an error curve. In another example, this comparison may include a ratio between a minimum value and a maximum value of an error curve. In an embodiment, a concavity measure may be based on one or more of a second derivative, a determinant of a Hessian matrix, the reciprocal of the signed radius of a tangent circle, and the radius of a best-fitting circle.

In an embodiment, a confidence determination may be based at least in part on a comparison between an error curve and one or more previous or ideal error curves. For example, a high correlation between an error curve and an ideal error curve may suggest high confidence, while a lower correlation between an error curve and an ideal error curve may suggest a lower confidence. In an embodiment, a confidence determination may be based on the Pearson correlation coefficient between two error curves, and may be calculated in accordance with

$$\frac{1}{T - 1} {\sum }_{i = 1}^{T} ( \frac{{x}_{i} - \overline{x}}{{s}_{x}} ) ( \frac{{y}_{i} - \overline{y}}{{s}_{y}} ) \qquad ( 26 )$$

where T is the number of samples of an error curve; xᵢ and yᵢ are the ith samples of error curves x and y, respectively; x̅ and y̅ are the respective sample means; and sₓ and s_{y} are the respective sample standard deviations. A correlation between two error curves may be calculated in accordance with any correlation calculation techniques, including those described in U.S. patent application Ser. No. 12/398,826, filed Mar. 5, 2009, entitled “SYSTEMS AND METHODS FOR MONITORING HEART RATE AND BLOOD PRESSURE CORRELATION,” which is incorporated by reference herein in its entirety.

In an embodiment, a plurality of error curves using a least median squares error metric may be generated. Each error curve may represent, for example, data taken from a patient over a particular time interval, with multiple error curves representing multiple time intervals. Multiple error curves may also arise from measurements taken at multiple sites on a patient's body, or any combination of multiple sites and multiple intervals. In an embodiment, a plurality of error curves may be combined to generate a combined error curve. A combined error curve may be generated by taking any suitable linear or non-linear combination of a plurality of error curves. For example, a plurality of error curves may be averaged to generate a combined error curve. In an embodiment, the N most recently generated error curves may be averaged to generate a combined error curve. A combined error curve may be generated from a plurality of error curves representing past time instances and/or time intervals by an FIR filter (e.g., a moving average filter), an IIR filter, or a combination of the two. For example, a combined error curve at time instance t, e_{comb}(t), may be calculated in accordance with

e_{comb}(t)=w·e_{new}+(1−w)·e_{comb}(t−1), (27)

where w is a weight between 0 and 1 associated with a new error curve e_{new}. Such an embodiment may be implemented as an IIR filter. In an embodiment, multiple error curves may be combined by concatenating the underlying parameter/error value data into a combined error curve data set.

In an embodiment, combining a plurality of error curves is based at least in part on a confidence associated with each error curve. The confidence may be determined as described above, or may be determined by another suitable means (e.g., by signal quality monitoring circuitry included, for example, in any of the components of patient monitoring system 10, an electromagnetic noise measuring device or a signal arising from sensor 418 indicating a malfunction or undesirable operating condition). In an embodiment, an associated confidence may be used to “weight” one or more of the plurality of error curves in a weighted average to generate a combined error curve. In such an embodiment, a higher confidence may result in a higher weight for a particular error curve within the weighted average. For example, a combined error curve, e_{comb}, may be calculated in accordance with

$${e}_{comb} = {\sum }_{i = 1}^{N} {w}_{i} {x}_{i} , \qquad ( 28 )$$

where N represents the total number of error curves to be combined, wᵢ represents the weight associated with error curve i and xᵢ represents error curve i. The weight wᵢ may be calculated in any of a number of ways. In an embodiment, the weight wᵢ is a monotonic function of any of the confidence measures described above. In an embodiment, a weight may be a linear or non-linear transformation of a single confidence measure, or a linear or non-linear combination of multiple confidence measures. In an embodiment, a weight w may be a computed as

w=ƒ(m₁,m₂,m₃), (29)

where ƒ is a linear or non-linear function of three confidence measures, m₁, m₂, and m₃. A relative weight may also be computed. For example, given three confidence measures, m(t), m(t−1), m(t−2), and three error curves, e(t), e(t−1), and e(t−2), where m(t) is the value of a confidence measure at time t, and e(t) is the error curve at time t, relative weights may be calculated in accordance with:

$$\begin{matrix}r ( t ) = \frac{m ( t ) - min ( m ( t ) , m ( t - 1 ) )}{max ( m ( t ) , m ( t - 1 ) ) - min ( m ( t ) , m ( t - 1 ) )} , & ( 30 ) \\ r ( t - 1 ) = \frac{m ( t - 1 ) - min ( m ( t ) , m ( t - 1 ) )}{max ( m ( t ) , m ( t - 1 ) ) - min ( m ( t ) , m ( t - 1 ) )} , & ( 31 ) \\ r ( t - 2 ) = \frac{m ( t - 2 ) - min ( m ( t ) , m ( t - 2 ) )}{max ( m ( t ) , m ( t - 2 ) ) - min ( m ( t ) , m ( t - 2 ) )} & ( 32 )\end{matrix}$$

In an embodiment, a combined error curve, e_{comb}, may then be calculated in accordance with:

e_{comb}=r(t)e(t)+r(t−1)e(t−1)+r(t−2)e(t−2). (33)

Error curves may also be combined via any suitable nonlinear combination, which may or may not include weights as described above.

In an embodiment, the M most recent error curves with highest confidence may be used to generate a combined error curve. The value of M may be static or may be dynamically adjusted based at least in part on the associated confidences of the plurality of error curves. For example, M may be smaller when error curves are associated with high confidences than when error curves are associated with low confidences.

In an embodiment, combining a plurality of error curves may include a threshold test on one or more of the associated confidences. The threshold test may determine the degree to which an error curve should be included in a combination. Generally, a threshold test on a value may test any of a number of threshold conditions, including whether the value exceeds a single threshold, whether the value is below a single threshold, or whether the value falls within a specified range or ranges. The threshold test may be fixed, and retrieved by processor 412 from ROM 52 or RAM 54. The threshold test may be dynamic and depend, for example, on previously determined information, previously calculated error curve confidences, confidences of one or more error curves, or any combination thereof. The threshold test may also depend on secondary signal quality indicators, which may arise from signal quality monitoring circuitry included, for example, in any of the components of patient monitoring system 10 or an electromagnetic noise measuring device or a signal arising from sensor 418 indicating a malfunction or undesirable operating condition. In an embodiment, an error curve may be included in the combination if its associated confidence exceeds a threshold, and may not be included otherwise. In an embodiment, an error curve may be included in the combination with a first weight if an associated confidence exceeds a first threshold, and may be included in the combination with a second, higher weight if the associated confidence exceeds a second, higher threshold. These specific embodiments are illustrative, and appropriate threshold tests may include any number of threshold conditions and resulting implications for the error curve combination calculation.

As discussed above, least mean squares techniques are often amenable to closed form solutions, which may be computationally advantageous in certain applications. However, such techniques are not robust to outlier data and thus may not be suitable for periods or conditions in which a signal is subject to noise. Moreover, alternate regression techniques exhibit different robustness to noise with different characteristics (e.g., Gaussian noise, or noise arising from patient movement). In an embodiment, a least median squares technique includes determining a noise characteristic and performing one of a plurality of regression analyses based at least in part on the noise characteristic. In an embodiment, at least one of the plurality of regression analyses is a least median squares regression. In an embodiment, a trimmed least mean squares regression may be used. In an embodiment, a principal component analysis may be performed. For example, the first principal component of a two-dimensional principal components analysis may be used to determine a best fit curve, while the second principal component may be used as a measure of noise and/or confidence.

FIG. 7 is a flow chart 700 of illustrative steps for determining information from a noise characteristic using a least median squares technique. At step 702, a noise characteristic is determined. A noise characteristic may include any assessment of noise interfering with or obscuring a signal communicating information about a process of interest, such as a physiological process monitored by patient monitoring system 10. Examples of noise characteristics include, but are not limited to: a noise magnitude, a noise frequency, a noise duration, a noise type (e.g., mechanical noise or hardware noise), a noise source (e.g., patient movement), a noise distribution (e.g., Gaussian or lognormal), or any combination thereof. Noise may be characterized at step 702 by analyzing any one or more of a first received signal (e.g., a signal received at step 502 of flow chart 500), a second received signal, a noise detection signal (e.g., as may arise from dedicated noise detection circuitry included in any of the components of patient monitoring system 10), an error curve (e.g., error curve 602), a manipulated error curve, a combined error curve, or any suitable signal communicating information about a noise source. In an embodiment, a noise characteristic is based on any one or more of the confidence determination techniques described above. In such an embodiment, noise and confidence may have an inverse or complementary relationship, and thus a confidence determination may be used to determine a noise characteristic, and vice versa.

In an embodiment, noise may be characterized by analyzing a representation of the signal in another domain. For example, a wavelet transformation may be applied to a time domain signal to generate a scalogram as described above. Noise characteristics may be determined by analyzing the scalogram representation of a signal. The amount of useful information about the physiological process of interest may vary between different regions in a scalogram. Certain types of noise and artifact may influence certain regions more than others, with such interference often reducing the amount of useful information that can be obtained from the region. For example, patient movement may distort the scale bands associated with lower scales, while certain types of hardware noise may distort the scale bands associated with higher scales. Assessing an amount of noise may involve detecting a characteristic scalogram feature, such as a feature corresponding to the noise signature of a hardware device in the environment. Assessing an amount of noise may involve detecting an abnormality in features of the scalogram, such as those that arise in a PPG scalogram during patient movement. The amount of noise may be assessed by a quantitative or qualitative assessment.

In an embodiment, noise may be characterized at step 702 by using a neural network processing technique to determine noise characteristics from any of the above described signals or error curves. In an embodiment, a neural network technique may include training a neural network (implemented, for example, in processor 412) to detect different types, sources and/or distributions of noise from a training set of error curves generated using a least median squares error metric.

Once a noise characteristic is determined at step 702, the noise characteristic may be compared to a set of noise criteria at step 704. The set of noise criteria employed at step 704 may include one or more criteria against which a noise characteristic may be compared in order to determine which of a plurality of regression analyses to perform in subsequent steps. Noise criteria may include, but are not limited to: a noise magnitude threshold, a noise frequency range, a noise duration threshold, a noise type category, a noise source category, a noise distribution category, or any combination thereof. The comparison of step 704 may take the form of a threshold test, as described above.

At step 706, one or more of a plurality of regression analyses is performed based at least in part on the comparison at step 704. Examples of regression analyses may include, but are not limited to: linear regressions, non-linear regressions, single variable regressions, multivariable regressions, least mean squares error metrics, least median squares error metrics, least mean absolute error metrics, least maximum error metrics, least mean nth power error metrics, any other suitable error metric, or any combination thereof. Several specific embodiments are described below as illustrative examples, but it will be understood that the systems and methods disclosed herein may be applied to any of a number of signal analysis applications employing a least median squares technique, including those described herein. In suitable embodiments, a threshold criteria may be evaluated by applying a hypothesis test or any other decision system, such as a neural network classifier.

In an embodiment, a threshold test may be applied to a noise magnitude estimate (determined, e.g., at step 702) to determine which of a plurality of regression analyses to perform at step 706. In an embodiment, a threshold test may include the following determinations:

If noise<thresh₁, use a least mean squares regression.

If thresh₁<noise<thresh₂, use a least median squares regression.

If thresh₂<noise, use a least mean squares regression.

In an alternate embodiment, if thresh₂<noise, no regression analysis may be performed.

In an embodiment, a threshold test on a noise magnitude estimate may include the following determinations:

If noise<thresh₁, use N data points in a least median squares regression.

If thresh₁<noise, use M data points in a least median squares regression, where M>N.

The values of M and N may be fixed, or may be dynamically determined based on the noise magnitude estimate and/or the relationship between the noise magnitude estimate and the value of thresh₁.

In an embodiment, a threshold test on a noise characteristic estimate may include the following determinations:

If the percentage of outliers in the data is greater than thresh₁, do not perform a regression analysis.

If the percentage of outliers in the data is less than thresh₁, use a least median squares regression.

It will be understood that the systems and methods described herein include any combination of the above-described embodiments, as well as any combination of the noise characteristics and noise criteria described above. Additionally, the systems and methods described herein (e.g., systems for implementing the steps illustrated in one or more of flow charts 500 and 700) may be applied to time domain signals, wavelet domain signals, signals in any suitable domain, or any combination thereof. It will also be understood that the above method may be implemented using any human-readable or machine-readable instructions on any suitable system or apparatus, such as those described herein.

The foregoing is merely illustrative of the principles of this disclosure and various modifications can be made by those skilled in the art without departing from the scope and spirit of the disclosure. The following claims may also describe various aspects of this disclosure.

What is claimed is:

1. A method for determining information from a signal, comprising:
receiving, from a first sensor, a first electronic signal;
receiving, from a second sensor, a second electronic signal;
using processor equipment for:
generating a Lissajous figure based at least in part on the first and second electronic signals,
determining information from at least the Lissajous figure based at least in part on a least median squares technique; and
outputting the information to an output device.

2. The method of claim 1, wherein the first electronic signal is a first photoplethysmograph signal and the second electronic signal is a second photoplethysmograph signal.

3. The method of claim 1, wherein the information is a blood oxygen saturation measurement.

4. The method of claim 1, wherein the least median squares technique comprises determining a least median squares regression line within the Lissajous figure.

5. The method of claim 1, wherein the least median squares technique comprises generating an error curve using a median squares error metric.

6. The method of claim 5, wherein the least median squares technique comprises generating a combined error curve by combining a plurality of error curves.

7. The method of claim 5, wherein the least median squares technique comprises determining a confidence based at least in part on the error curve.

8. The method of claim 1, wherein the least median squares technique comprises:
determining a noise characteristic; and
performing one of a plurality of regression analyses based at least in part on the noise characteristic, wherein one of the plurality of regression analyses is a least median squares regression.

9. A system for determining information from a signal, comprising:
processing equipment capable of
receiving, from a first sensor, a first electronic signal,
receiving, from a second sensor, a second electronic signal,
generating a Lissajous figure based at least in part on the first and second electronic signals, and
determining information from at least the Lissajous figure based at least in part on a least median squares technique; and
an output device, communicatively coupled to the processing equipment, for outputting the information.

10. The system of claim 9, wherein the first electronic signal is a first photoplethysmograph signal and the second electronic signal is a second photoplethysmograph signal.

11. The system of claim 9, wherein the information is a blood oxygen saturation measurement.

12. The system of claim 9, wherein the least median squares technique comprises determining a least median squares regression line within the Lissajous figure.

13. The system of claim 9, wherein the least median squares technique comprises generating an error curve using a median squares error metric.

14. The system of claim 13, wherein the least median squares technique comprises generating a combined error curve by combining a plurality of error curves.

15. The system of claim 13, wherein the least median squares technique comprises determining a confidence based at least in part on the error curve.

16. The system of claim 9, wherein the least median squares technique comprises:
determining a noise characteristic; and
performing one of a plurality of regression analyses based at least in part on the noise characteristic, wherein one of the plurality of regression analyses is a least median squares regression.

17. Computer-readable medium for use in determining information from a signal, the computer-readable medium having computer program instructions recorded thereon for:
receiving, from a first sensor, a first electronic signal;
receiving, from a second sensor, a second electronic signal;
generating a Lissajous figure based at least in part on the first and second electronic signals;
determining information from at least the Lissajous figure based at least in part on a least median squares technique; and
outputting the information to an output device.

18. The computer-readable medium of claim 17, wherein the first electronic signal is a first photoplethysmograph signal and the second electronic signal is a second photoplethysmograph signal.

19. The computer-readable medium of claim 17, wherein the information is a blood oxygen saturation measurement.

20. The computer-readable medium of claim 17, wherein the least median squares technique comprises determining a least median squares regression line within the Lissajous figure.
